(19) United States
(12) Patent Application Publication
(10) Pub. No.: US 2002/0124446 A1
(43) Pub. Date: Sep. 12, 2002

(54) Christmas decorative box

(76) Inventor: Fu-Shien Hsu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/803,113

(22) Filed: Mar. 12, 2001

(51) Int. Cl. G09F 13/00

(52) U.S. Cl. 40/442

(57) ABSTRACT

The present invention relates to a Christmas decorative box, which includes a lighting source and lighting fibers. The outer end of the lighting fiber can be extended and connected with the shell of the box at the surrounding positions. When the lighting source is lighting, the light can be emitted through the lighting fiber to the surrounding surface of the box to obtain a multiple lighting spots for a whole lighting mask decorative effect.

### BACKGROUND OF THE INVENTION

A conventional Christmas decorative box is usually designed to be a special construction for attracting people. Some decorative boxes are provided with a single lighting source inside to increase the decorative effect by the lighting. But in this structure, the light can only emit outside from the few opening of the box, such as the windows, and the lighting effect will be limited because of the most untransparent parts of the box.

Accordingly, the primary object of the invention is to provide a Christmas decorative box, which is provided with lighting fibers to emit the light at whole environment of the box that obtains a novel decorative effect. Now the features and advantages of the present invention will be described in detail with reference to the accompanying drawings.

### BRIEF DESCRIPTION OF ACCOMPANYING DRAWINGS

FIG. 1 is a perspective view showing a Christmas decorative box according to the present invention.

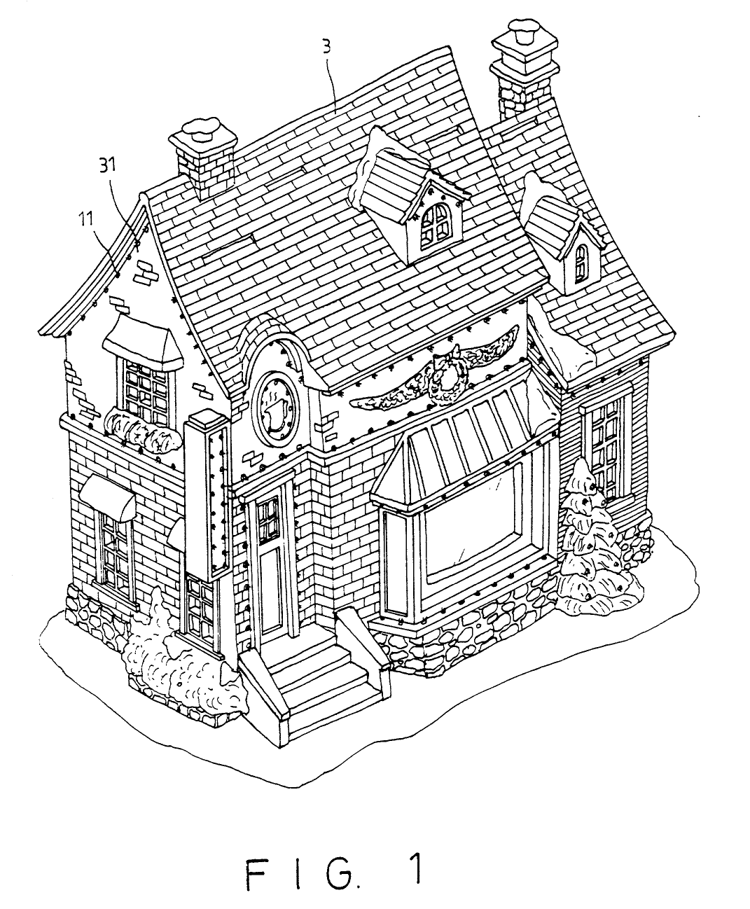

FIG. 2 is a plan view showing the inside structure of FIG. 1 according to the present invention.

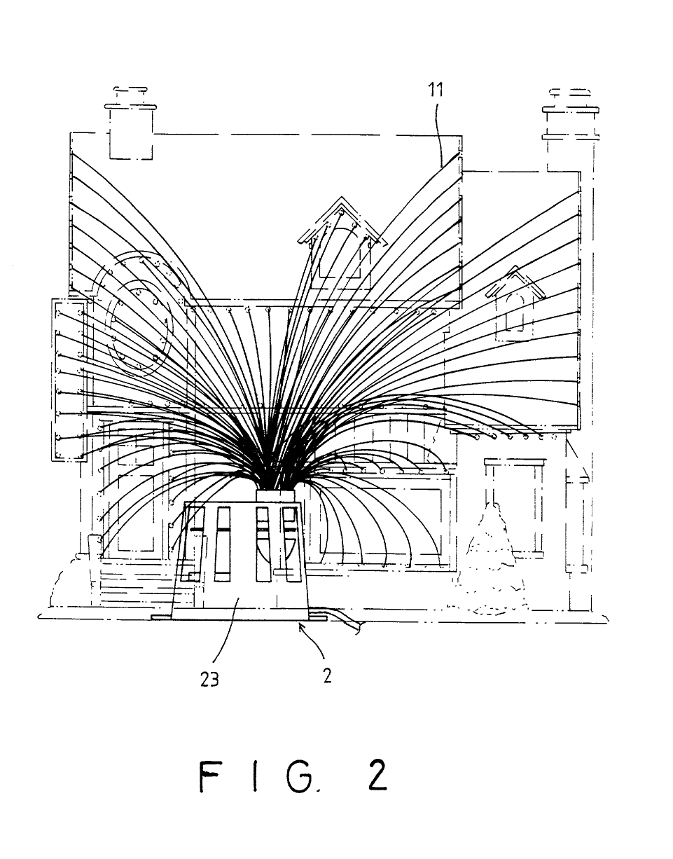

FIG. 3 is an exploded perspective view of a lighting source according to the present invention.

FIG. 4 is a perspective view showing the lighting fibers being connected with the shell of the box according to the present invention.

### DETAILED DESCRIPTION OF PREFERRED EMBODIMENTS

Referring to the attached figures, the present invention can be applied to all hollow Christmas decorative box (3), which is provided with a lighting source (2) and lighting fibers (1) inside, wherein the fibers (1) can be extended to the surrounding surface of the decorative box (3) to obtain a whole lighting effect.

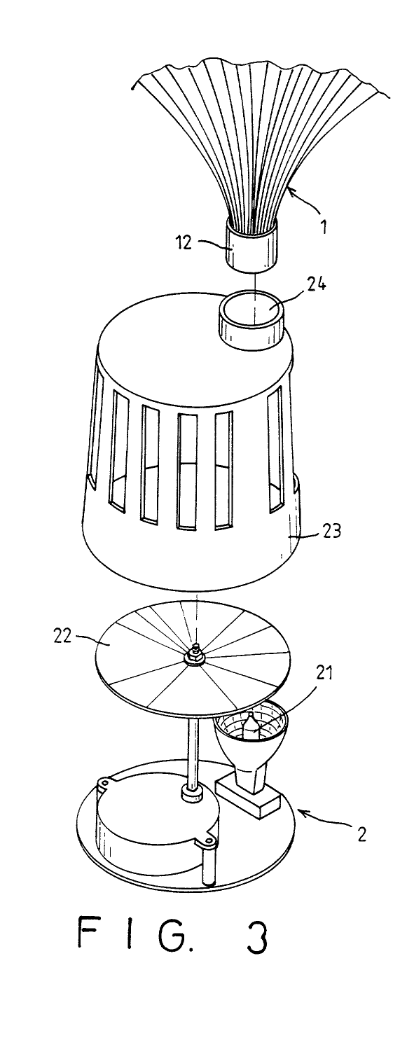

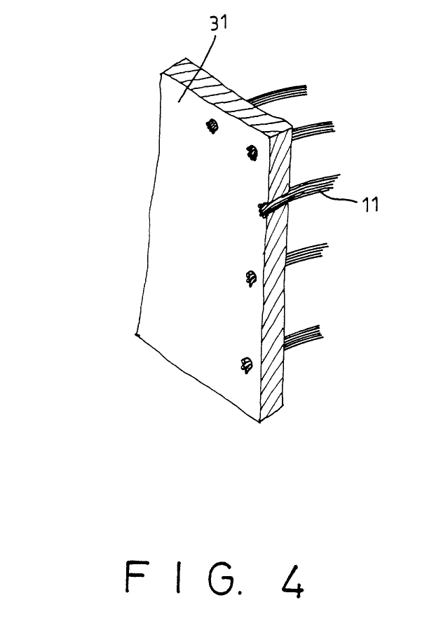

The lighting source (2) of the present invention is shown in FIG. 3, which includes a bulb (21) with an upper rotatable plate (22) and a cover (23) having a connecting hole (24). The lighting fibers (1) are combined by a sleeve (12) at lower end to be engaged within the hole (24) of the cover (23). Each fiber (11) of the lighting fibers (1) can be extended radiatively and the outer end of the fiber (11) can be connected within the shell (31) of the box (3) as shown in FIG. 4. In this embodiment of the present invention, there are some lighting fibers (11) to be a unit, which is mounted on the box (3) with an exposed end. The environment of the box (3) can be provided the units of the lighting fibers (11) as lighting spots. When the lighting source (2) is lighting, the single bulb (21) provides the light to emit by the lighting fiber (11) radiatively. The decorative box (3) can display a plurality of lighting spots on the surrounding as a lighting mask to increase highly decorative lighting effect. Moreover, the lighting effect can be sparkled by rotating the lighting plate (22) over the bulb (21) for a various decoration.

As above mentioned, the present invention obviously gains the utility and novelty for patent and is thus applied.

What is claimed is:

1. A Christmas decorative box including a hollow decorative box with a lighting source inside provided with a single bulb and lighting fibers, wherein the outer end of each lighting fiber is radiatively extended outward and connected within a desired position of the shell of the box having an exposed end; and the light of the single bulb being emitting through the lighting fiber to shine the whole surrounding of the decorative box for a lighting mask of decoration.

2. The Christmas decorative box as claimed in claim 1, wherein the lighting source including a single bulb with an upper plate be rotatable and a cover having a connecting hole, while the lighting fibers being combined by a sleeve at the lower end to be engaged within the hole on the cover relating to the bulb.
